(19) United States
(12) Patent Application Publication
(10) Pub. No.: US 2026/0052116 A1
(43) Pub. Date: Feb. 19, 2026

(54) ARTIFICIAL INTELLIGENCE CHATBOTS FOR USE WITH ENERGY MANAGEMENT SYSTEMS

(71) Applicant: Enphase Energy, Inc., Petaluma, CA (US)

(72) Inventors: Preetam PINNADA, Visakhapatnam (IN); Ashish BANSAL, Bengaluru (IN); Nitish MATHUR, Fremont, CA (US); Khushi DHOLAKIA, Hayward, CA (US); Prasanna ROTTI, San Jose, CA (US); Abhijit Balwant JOSHI, San Jose, CA (US); Jinendra Kacharulal GUGALIYA, Mahadevapura (IN); Amit Kumar YADAV, Uttar Pradesh (IN); Agam SHUKLA, Uttar Pradesh (IN); Subhasis CHAKRABORTY, Kolkata – 52 (IN); Alladi AJAY, Guntur (IN)

(21) Appl. No.: 19/283,863

(22) Filed: Jul. 29, 2025

(30) Foreign Application Priority Data
Aug. 19, 2024 (IN) 202411062608

(51) Int. Cl. H04L 51/02; G06F 40/35; G06Q 30/015

(52) U.S. Cl. CPC H04L 51/02; G06F 40/35; G06Q 30/015

(57) ABSTRACT

An apparatus for use with energy management systems is provided and comprises a user interface and a Chatbot in operable communication with the user interface for receiving a query and transmitting a response to the query and in operable communication with at least one of a large language model (LLM) tool/agent, a LLM service, customer service (CS) agent, or storage layer for developing the response to the query.

### CROSS-REFERENCE TO RELATED APPLICATIONS

The present disclosure claims the benefit of and priority to Indian Provisional Application No. 202411062608, filed on Aug. 19, 2024, the entire contents of which is incorporated herein by reference.

### BACKGROUND

### 1. Field of the Disclosure

Embodiments of the present disclosure generally relate to energy management systems and, for example, to Artificial Intelligence (AI) chatbots for use with energy management systems.

### 2. Description of the Related Art

Conventional power conversion systems (energy management systems) are very well known, and customer support (CS) solely through human agents is not a scalable solution and is not efficient due to the numerous amounts of information that is scattered across the tool chain, which is not easily available to the CS team in actionable format.

Therefore, described herein are improved AI Chatbots for use with energy management systems.

### SUMMARY

In accordance with some aspects of the present disclosure, there is provided an apparatus for use with energy management systems. The apparatus comprises a user interface and a Chatbot in operable communication with the user interface for receiving a query and transmitting a response to the query and in operable communication with at least one of a large language model (LLM) tool/agent, a LLM service, a customer service (CS) agents, or a storage layer for developing the response to the query.

In accordance with some aspects of the present disclosure, there is provided an energy management system comprising a distributed energy resource (DER) comprising a microinverter, a distributed energy resource (DER) controller in operative communication with a cloud-based computing platform, a user interface, and a Chatbot in operable communication with the user interface for receiving a query and transmitting a response to the query and in operable communication with at least one of a large language model (LLM) tool/agent, a LLM service, a customer service (CS) agent, or a storage layer for developing the response to the query.

Various advantages, aspects, and novel features of the present disclosure may be appreciated from a review of the following detailed description of the present disclosure, along with the accompanying figures in which like reference numerals refer to like parts throughout.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only a typical embodiment of this disclosure and are therefore not to be considered limiting of its scope, for the disclosure may admit to other equally effective embodiments.

FIG. 1 is a block diagram of a system for power conversion, in accordance with at least some embodiments of the present disclosure;

FIG. 2 is a diagram of a homeowner (HO) Chatbot workflow for use with the system for power conversion of FIG. 1, in accordance with at least some embodiments of the present disclosure;

FIG. 3 is a diagram of a homeowner (HO) Chatbot architecture for use with the system for power conversion of FIG. 1, in accordance with at least some embodiments of the present disclosure;

FIG. 4 is a diagram of an artificial intelligence/machine learning (AI/ML) enabled advanced fleet monitoring system for use with the system for power conversion of FIG. 1, in accordance with at least some embodiments of the present disclosure; and

FIG. 5 is a flowchart of a customer support Chatbot workflow for use with the system for power conversion of FIG. 1, in accordance with at least some embodiments of the present disclosure.

### DETAILED DESCRIPTION

In accordance with the present disclosure described herein are improved AI Chatbots for use with energy management systems. For example, apparatus can comprise a user interface and a Chatbot in operable communication with the user interface for receiving a query and transmitting a response to the query and in operable communication with at least one of a large language model (LLM) tool/agent, LLM service, a customer service (CS) agent, or a storage layer for developing the response to the query. The inventive concepts described herein provide LLM Chatbots configured to use chain-of-thought prompting, configured to use retrieval-augmented generation (RAG) framework, and configured to integrate with domain specific models and applications. Compared to conventional Chatbots, which have pre-defined menus and workflows or respond based on a corpus of text, the LLM Chatbots described herein use rich insights by calling AI models/tools, e.g., in the context of microinverters and/or solar systems.

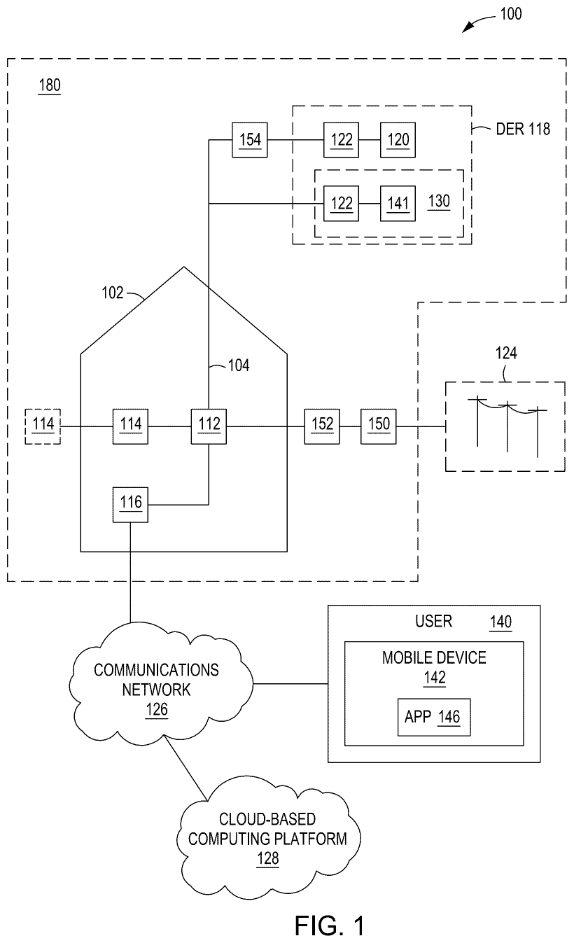

FIG. 1 is a block diagram of an energy management system (e.g., power conversion system, system 100) in accordance with one or more embodiments of the present disclosure. The diagram of FIG. 1 only portrays one variation of the myriad of possible system configurations. The present disclosure can function in a variety of environments and systems.

The system 100 comprises a structure 102 (e.g., a user's structure, such as a home), such as a residential home, commercial building, or separate mounting structure, having an associated DER 118 (distributed energy resource). The DER 118 is situated external to the structure 102. For example, the DER 118 may be located on the roof of the structure 102 or can be part of a solar farm. Alternatively, the DER 118 can be situated internal to the structure 102. For example, when the DER 118 is a permanent residential battery energy storage system, the DER 118 may be installed in a garage (or other suitable location inside the structure 102). The structure 102 comprises one or more loads and/or energy storage devices 114 (e.g., portable energy systems (PES), appliances, electric hot water heaters, thermostats/detectors, boilers, electric vehicle supply equipment (EVSE), EVs, water pumps, and the like), which can be located within or outside the structure 102, and a DER controller 116, each coupled to a load center 112. Although the energy storage devices 114, the DER controller 116, and the load center 112 are depicted as being located within the structure 102, one or more of these may be located external to the structure 102.

The load center 112 is coupled to the DER 118 by an AC bus 104 and is further coupled, via a meter 152 (utility meter comprising a utility meter socket) and optionally a MID 150 (microgrid interconnect device), to a grid 124 (e.g., a commercial/utility power grid). The structure 102, the energy storage devices 114, DER controller 116, DER 118, load center 112, generation meter 154, the meter 152, and the MID 150 are part of a microgrid 180. It should be noted that one or more additional devices not shown in FIG. 1 may be part of the microgrid 180. For example, a power meter or similar device may be coupled to the load center 112.

The DER 118 comprises at least one renewable energy source (RES) coupled to power conditioners 122 (e.g., microinverter, power converter, power conversion units (PCUs), etc.). For example, the DER 118 may comprise a plurality of RESs 120 coupled to a plurality of power conditioners 122 in a one-to-one correspondence (or two-to-one). In embodiments described herein, each RES of the plurality of RESs 120 is a photovoltaic module (PV module), although in other embodiments the plurality of RESs 120 may be any type of system for generating DC power from a renewable form of energy, such as wind, hydro, and the like. The DER 118 may further comprise one or more batteries (or other types of energy storage/delivery devices) coupled to the power conditioners 122 in a one-to-one correspondence, where each pair of power conditioner 122 and a DC battery 141 may be referred to as an AC battery 130.

The power conditioners 122 invert the generated DC power from the plurality of RESs 120 and/or the DC battery 141 to AC power that is grid-compliant and couple the generated AC power to the grid 124 via the load center 112. The generated AC power may be additionally or alternatively coupled via the load center 112 to the one or more loads (e.g., EV, EVSE) and/or the energy storage devices 114. In addition, the power conditioners 122 that are coupled to the DC batteries convert AC power from the AC bus 104 to DC power for charging the DC batteries. A generation meter 154 is coupled at the output of the power conditioners 122 that are coupled to the plurality of RESs 120 in order to measure generated power.

In at least some embodiments, the power conditioners 122 may be AC-AC converters that receive AC input and convert one type of AC power to another type of AC power. Alternatively, the power conditioners 122 may be DC-DC converters that convert one type of DC power to another type of DC power. The DC-DC converters may be coupled to a main DC-AC inverter for inverting the generated DC output to an AC output.

The power conditioners 122 may communicate with one another and with the DER controller 116 using power line communication (PLC), although additionally and/or alternatively other types of wired and/or wireless communication may be used. The DER controller 116 may provide operative control of the DER 118 and/or receive data or information from the DER 118. For example, the DER controller 116 may be a gateway that receives data (e.g., alarms, messages, operating data, performance data, and the like) from the power conditioners 122 and communicates the data and/or other information via the communications network 126 to a cloud-based computing platform 128, which can be configured to execute one or more application software, e.g., a grid connectivity control application, to a remote device or system such as a master controller (not shown), and the like. The DER controller 116 may also send control signals to the power conditioners 122, such as control signals generated by the DER controller 116 or received from a remote device or the cloud-based computing platform 128. The DER controller 116 may be communicably coupled to the communications network 126 via wired and/or wireless techniques. For example, the DER controller 116 may be wirelessly coupled to the communications network 126 via a commercially available router. In one or more embodiments, the DER controller 116 comprises an application-specific integrated circuit (ASIC) or microprocessor along with suitable software (e.g., a grid connectivity control application) for performing one or more of the functions described herein (e.g., the methods described herein).

The generation meter 154 (which may also be referred to as a production meter) may be any suitable energy meter that measures the energy generated by the DER 118 (e.g., by the power conditioners 122 coupled to the plurality of RESs 120). The generation meter 154 measures real power flow (kWh) and, in some embodiments, reactive power flow (kVAR). The generation meter 154 may communicate the measured values to the DER controller 116, for example using PLC, other types of wired communications, or wireless communication. Additionally, battery charge/discharge values are received through other networking protocols from the DC battery itself.

The meter 152 may be any suitable energy meter that measures the energy consumed by the microgrid 180, such as a net-metering meter, a bi-directional meter that measures energy imported from the grid 124 and well as energy exported to the grid 124, a dual meter comprising two separate meters for measuring energy ingress and egress, and the like. In some embodiments, the meter 152 comprises the MID 150 or a portion thereof. The meter 152 measures one or more of real power flow (kWh), reactive power flow (kVAR), grid frequency, and grid voltage. The meter 152 measures power flows independently of MID state, i.e., when MID is closed and DER's are connected to the grid and when MID is open and DER's are isolated from the grid.

The MID 150, which may also be referred to as an island interconnect device (IID), connects/disconnects the microgrid 180 to/from the grid 124. The MID 150 comprises a disconnect component (e.g., a, relay, a contactor, or the like) for physically connecting/disconnecting the microgrid 180 to/from the grid 124. For example, the DER controller 116 receives information regarding the present state of the system from the power conditioners 122, and also receives the energy consumption values of the microgrid 180 from the meter 152 (for example via one or more of PLC, other types of wired communication, and wireless communication), and based on the received information (inputs), the DER controller 116 determines when to go on-grid or off-grid and instructs the MID 150 accordingly. In some alternative embodiments, the MID 150 comprises an ASIC or CPU, along with suitable software (e.g., an islanding module) for determining when to disconnect from/connect to the grid 124. For example, the MID 150 may monitor the grid 124 and detect a grid fluctuation, disturbance or outage and, as a result, disconnect the microgrid 180 from the grid 124. Once disconnected from the grid 124, the microgrid 180 can continue to generate power as an intentional island without imposing safety risks, for example on any line workers that may be working on the grid 124.

In some alternative embodiments, the MID 150 or a portion of the MID 150 is part of the DER controller 116. For example, the DER controller 116 may comprise a CPU and an islanding module for monitoring the grid 124, detecting grid failures and disturbances, determining when to disconnect from/connect to the grid 124, and driving a disconnect component accordingly, where the disconnect component may be part of the DER controller 116 or, alternatively, separate from the DER controller 116. In some embodiments, the MID 150 may communicate with the DER controller 116 (e.g., using wired techniques such as power line communications, or using wireless communication) for coordinating connection/disconnection to the grid 124.

A user 140 can use one or more computing devices, such as a mobile device 142 (e.g., a smart phone, tablet, or the like) communicably coupled by wireless means to the communications network 126. The mobile device 142 has a CPU, support circuits, and memory, and has one or more applications (e.g., a grid connectivity control application (an application 146)) installed thereon for controlling the connectivity with the grid 124 as described herein. The mobile device 142 may run on commercially available operating systems, such as IOS, ANDROID, and the like.

In order to control connectivity with the grid 124, the user 140 interacts with an icon displayed on the mobile device 142, for example a grid on-off toggle control or slide, which is referred to herein as a toggle button. The toggle button may be presented on one or more status screens pertaining to the microgrid 180, such as a live status screen (not shown), for various validations, checks and alerts. The first time the user 140 interacts with the toggle button, the user 140 is taken to a consent page, such as a grid connectivity consent page, under setting and will be allowed to interact with toggle button only after he/she gives consent.

Once consent is received, the scenarios below, listed in order of priority, will be managed differently. Based on the desired action as entered by the user 140, the corresponding instructions are communicated to the DER controller 116 via the communications network 126 using any suitable protocol, such as HTTP(S), MQTT(S), WebSockets, and the like. The DER controller 116, which may store the received instructions as needed, instructs the MID 150 to connect to or disconnect from the grid 124 as appropriate.

In accordance with at least some embodiments, described herein are AI chatbots (installer-facing and customer-facing) that are configured to significantly enhance customer service (experience) by automating one or more routine tasks and ensuring the availability of higher quality actionable information through Gen-AI large language model (LLM), which can be trained on data and documents. That is, the LLM are neural networks, which are machine learning models, take an input and perform mathematical calculations to produce an output, as described in greater detail below.

For example, improved AI Chatbots for use with energy management systems are provided herein. For example, with respect to customer experience, the AI solutions described herein can improve customer experience through LLM powered RAG chatbot applications, which would serve as a first point of contact or a self-service interface for one or more users (e.g., homeowners or installers), thus resulting in reduced CS call volume. Additionally, the AI solutions described herein can be used to generate content for a support website and/or community. With respect to productivity, business intelligence (BI) users (e.g., network operations center (NOC), engineer, executive, etc.) can query and analyze data using natural language. In at least some embodiments, the AI can be used for automated call summarization, tagging, and/or assist new CS agent training. In at least some embodiments, the AI applications can be augmented with one or more LLM tools (e.g., in-house machine learning (L) models and systems), can troubleshoot/ideate based on natural language instruction from CS agent, thus resulting in improved productivity and reduced mean call duration. With respect to quality, the LLMs described herein, which are capable of processing images, can be used to understand site geographic characteristics based on satellite images and can be used to generate connection diagrams for installers. Additionally, the LLMs (e.g., such as multi-modal LLMs) described herein can be used by engineers for root cause analysis, quality design insights, and/or generation of quick automation scripts and webpages.

Additionally, in accordance with at least some embodiments of the present disclosure, with respect to HO Chatbots, the training data can comprise support articles, user guides, whitepapers, warranty terms, and the like. The HO Chatbots can use a chat interface that can be menu based and accessible via a support website. The HO Chatbots can use one or more models/method, e.g., Einstein action bot (Chatbots that are easy to configure from Salesforce's User Interface)+Einstein grounding (the process of adding other context to the record so that the Large Language Model (LLM) has the information it needs to return a response that is correct and useful). The HO Chatbots are configured to allow a homeowner to ask the HO Chatbots about required information and execute certain actions without having to read the articles, dialing CS, etc.

Moreover, in accordance with at least some embodiments of the present disclosure, with respect to installer (IN) Chatbots, the training data can comprise support articles, user guides, whitepapers, warranty terms, installer guides, installer operating manuals, technical briefs, and the like. The IN Chatbots can use a chat interface that can be menu based and accessible via a support website. The IN Chatbots can use one or more models/method, e.g., Einstein action bot (Chatbots that are easy to configure from Salesforce's User Interface)+Einstein grounding (the process of adding other context to the record so that the Large Language Model (LLM) has the information it needs to return a response that is correct and useful). The IN Chatbots are configured to allow an installer to execute one or more authorized tasks using the IN Chatbots without having to navigate through multiple pages on one or more user applications.

Furthermore, in accordance with at least some embodiments of the present disclosure, with respect to CS Chatbots (e.g., foundational models (FMS)/LLM application), the training data can comprise CS wiki, Salesforce cases, and/or ML models output. The CS Chatbots can use a Q&A chat interface. The CS Chatbots can use one or more models/methods, e.g., RAG chat bot with ML models as integrated LLM tools. The CS Chatbots are configured to allow a CS agent to describe a problem to the CS Chatbots and get troubleshooting ideas and site summary resulting in reduced call duration.

Likewise, in accordance with at least some embodiments of the present disclosure, with respect to engineer Chatbots (e.g., root cause analysis (RCA)/LLM application), the training data can comprise design documents. The engineer Chatbot can use a Q&A chat interface. The engineer Chatbots can use one or more models/methods, e.g., RAG chat bot with ML models as integrated LLM tools. The engineer Chatbots are configured to allow an engineer to use the engineer Chatbot to gain insight regarding root cause analysis and/or product quality.

As can be appreciated, any of the training data, interface, models/methods, and purposes described above can be used with any of the HO Chatbots, IN Chatbots CS Chatbots, engineer Chatbots, e.g., the training data, interface, models/methods, and purposes of the HO Chatbots can also be used with the IN Chatbots, CS Chatbots, and/or engineer Chatbots, and vice versa. For example, the Einstein action bot+Einstein grounding methods/models of the HO Chatbots and the IN Chatbots can be used in addition to or in place of the RAG chat bot with ML models as integrated LLM tools of the CS Chatbots and the engineer Chatbots, and vice versa.

In accordance with at least some embodiments, the AI/ML described herein can be used for fleet management (e.g., case history, automated actions, causes). For example, the AI/ML described herein can be used to organize data in a data warehouse (DWH), clean/transform and prepare for AI/ML algorithm consumption. The AI/ML described herein can be used to detect anomalies in time series telemetry data using, for example, an autoencoder neural network. The AI/ML described herein can be used to cluster the anomalies to understand broader failure modes using, for example, K-Means algorithm. The AI/ML described herein can be used to enrich the anomalous telemetry records, i.e., with failure mode label, events data, site & device metadata, logs, and construct a dataset of episodes for each failure mode around the anomalous timestamps. The AI/ML described herein can be used to input the set of episodes/transactions to an association rule mining method (e.g., frequent pattern (FP)-growth algorithm) to discover correlations, lead indicators/predictors, and rules for each failure mode. If a failure mode has a well-defined predictor(s), the AI/ML described herein is configured to train a classifier (e.g., a binomial logistic regression model) on a dataset with forecast window (lag) as the lead time of the predictor. During inference on live streaming data, the AI/ML described herein is configured to use ensemble models viz. Bi-LR and FP-growth rules to derive a composite health score for each device and site indicating their RUL/TTF (e.g., remaining useful life/time to failure). The AI/ML described herein is configured to set alerts to notify downstream task automation to act when the composite health score drops below a critical threshold. The AI/ML can use an LLM that is RAG (e.g., digest textual knowledge articles, documents, metrics) customized or fine-tuned using a knowledge base (e.g., KDB, a vector database), which can be built from one or more of customer calls data, definitions, specifications, site case history, alerts, tasks, logs. The AI/ML described herein is configured to present a CS (e.g., call data analytics, such as audio transcription, call summarization, tags, etc.), an NOC (e.g., query tabular data in natural language for NOC reports), and an engineer with a site summary, trouble-shooting steps, RCA, similar cases, and/or an interactive chatbot to talk to the data.

The AI/ML described herein can be configured to provide any of the Chatbots described herein with the capability to fetch site information and execute various company platforms (e.g., Enlighten® (ENL) platform available from Enphase® Inc.) to perform tasks on behalf of the homeowner. The AI/ML described herein can be configured to understand satellite images, e.g., classifying sites with pool, pump, high altitude, edge of grid, etc. The AI/ML described herein can be configured to help an installer with system connections using augmented reality (AR), which can be trained on a Quick Installation Guide (QIG), diagrams, product images, etc. The AI/ML described herein can be configured to provide quick automation script generation for NOC/CX. The AI/ML described herein can be configured to provide design insights through circuit/netlist generation for hardware (HW) developers and quick content and wireframe generation for support and community.

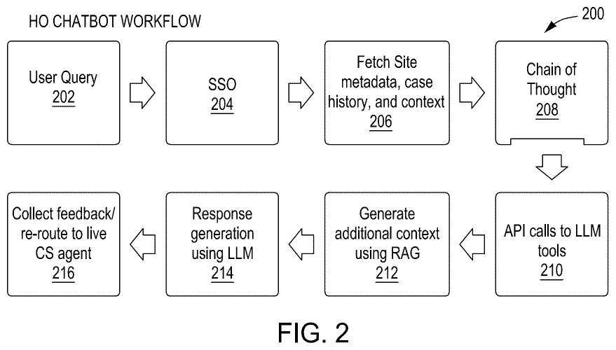

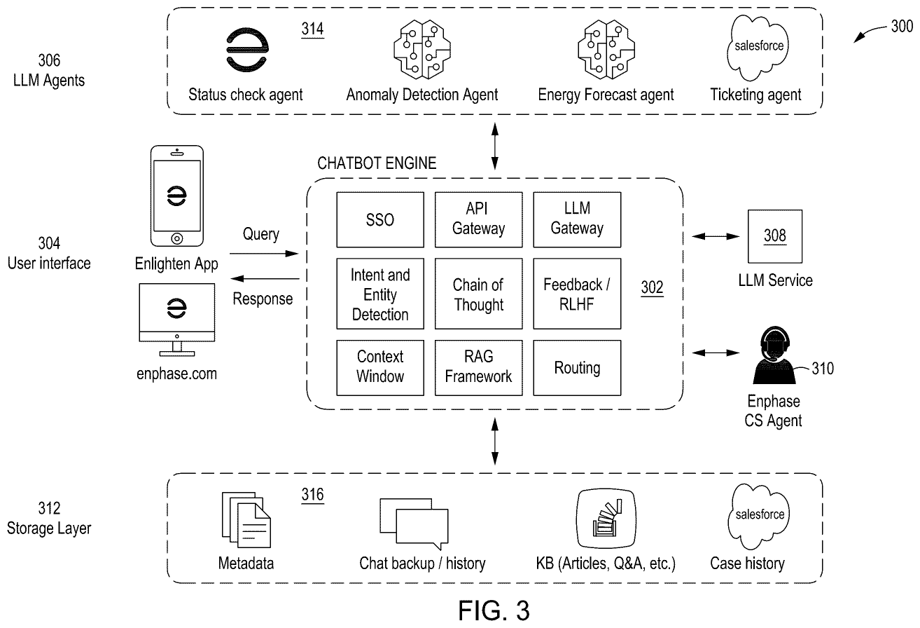

FIG. 2 is a diagram of a HO Chatbot workflow 200 for use with the system for power conversion of FIG. 1, and FIG. 3 is a diagram 300 of a homeowner (HO) Chatbot architecture for use with the system for power conversion of FIG. 1, in accordance with at least some embodiments of the present disclosure. For example, the HO Chatbot (e.g., a Chatbot engine 302) can be configured to respond to a customer (e.g., a HO input, via a user interface entered by way of application or web) with a step-by-step query resolution within site specific context (see 202 and 304). In at least some embodiments, the HO Chatbot can be configured to call one or more LLM tools/agents 306, LLM services 308, CS agents 310, and/or storage layers 312. In doing so, the HO Chatbot is configured to access external application programming interfaces (APIs) for single sign-on (SSO) services (e.g., a session and user authentication service that allows users to log in once with a single set of credentials to access multiple applications and systems) and/or case ticketing (see 204, 302, and 314). In at least some embodiments, the HO Chatbot is configured to retrieve relevant metadata (fetch site data), case history, and/or context (see 206 and 316). The HO Chatbot is configured to use chain-of-thought (CoT) prompting to identify a user's intent (see 208 and 302), e.g., a prompt engineering technique that significantly improves the performance of LLMs on complex reasoning tasks, thus encouraging the LLM to generate a sequence of intermediate reasoning steps to arrive at the solution. For example, the HO Chatbot can be configured to use API to call the one or more LLM tools/agents 306 (see 210). In at least some embodiments, at 210, if necessary, the HO Chatbot can be configured to call the one or more LLM tools/agents 306, which can be built inhouse by a company, to execute company products specific actions and/or services. In at least some embodiments, the LLM can have several LLM tools/agents (e.g., domain specific applications), such as one or more forecast models (energy forecast agent), advanced fleet monitoring systems ML insights, status check agent, anomaly agent, ticketing agent, and/or one or more APIs. For example, the HO Chatbot can be an LLM powered application, which uses RAG framework to ground the responses on one or more knowledge bases (e.g., connecting the LLM's generated output to verifiable and relevant sources of information). In at least some embodiments, the HO Chatbot can be configured to generate additional context (see 210). For example, the HO Chatbot can be configured to use one or more microinverter specific LLM agents along with RAG framework to provide a holistic chatbot experience. In at least some embodiments, the HO Chatbot can be configured to generate a response using the LLM (see 214). In view of the foregoing, the inventors have found that the HO Chatbot can improve iteratively by using reinforcement learning from human feedback (RLHF) and/or reroute to a live CS agent (see 216).

The inventive concepts described herein provide an integrated AI/ML solution. For example, the integrated AI/ML solution can provide a three layer solution. For example, a first layer (a predictive maintenance layer to detect problems) can be configured to identify field anomalies proactively and provide root-cause analysis. For example depending on the anomaly, the anomaly can be a category that is temporary (e.g., troubleshooting possible) or permanent (e.g., either a catastrophic event or a degrading state which is not preventable). In addition to the root-cause analysis, the first layer is also configured to capture time of onset of the anomaly and/or other features that are distinguishable from other anomalies. In at least some embodiments, the output from the first layer can be pushed to an observation platform. A second layer (an automation layer for auto recovery) can be configured to take/receive inputs from the first layer and automatically perform recovery/troubleshooting/tunneling/rma steps, which can prevent a probable future customer call. Once the recovery is successful, the second layer notifies the CS agent, installer and/or homeowner of the issue and the recovery. The troubleshooting steps (along with one or more other details) can be captured in the case notes before the second layer is auto-closed. If the recovery is unsuccessful, the steps performed can be recorded in the case notes and, based on the fault category, the case can be auto assigned to a specific agent, e.g., a specific agent who deals with such cases. A third layer (natural language solution layer for efficient CS) can be configured to integrate with one or more applications (e.g., energy management system control software, such as Enlighten® available from Enphase® Inc.) and the first and second layers. In doing so, a CS agent can quickly assemble numerous amounts of information (e.g., potential issues from the first layer and the second layer, case notes and automated troubleshooting, which have been already performed from the second layer, and/or other commonly used information from Enlighten) in one user interface (UI). In at least some embodiments, the third layer can also enable CS interaction with an observability platform using generative AI, which can greatly reduce time taken by CS to respond to issues.

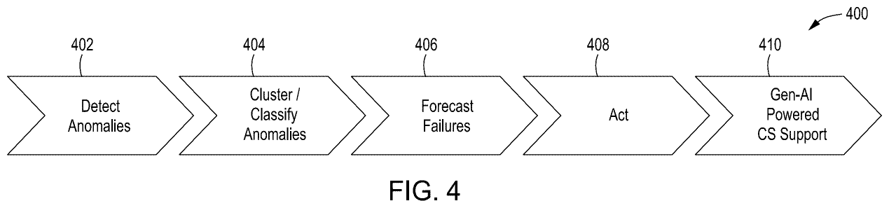

FIG. 4 is a diagram 400 of an artificial intelligence/machine learning (AI/ML) enabled advanced fleet monitoring system for use with the system for power conversion of FIG. 1, in accordance with at least some embodiments of the present disclosure. For example, as noted above the AI/ML described herein can be used for fleet management. For example, the AI/ML described herein can be configured to provide end-to-end workflow of an AI powered fleet monitoring system for enhanced customer experience, predictive maintenance, efficient redressal, quality and design insights, and/or discovery of novel failures. In at least some embodiments, the AI/ML described herein can be configured to enable internal efficiency/cost savings, scalability, and/or new recurring (high gross margin) revenue opportunity.

For example, in at least some embodiments the AI/ML described herein can be configured to enable the advanced fleet monitoring system to detect anomalies (see 402). For example, at 402, inputs to the AI/ML described herein can comprise telemetry data and events data and outputs from the AI/ML described herein can comprise a list of detected anomalies. Additionally, at 402, the AI/ML described herein can use one or more learning models/methods, such as logistic regression and autoencoder, which can provide real-time detection, as opposed to reactive analysis which conventional systems provide, and can benefit NOC and quality control.

Additionally, in at least some embodiments, the AI/ML described herein can be configured to enable the advanced fleet monitoring system to cluster/classify anomalies (see 404). For example, at 404 inputs to the AI/ML described herein can comprise a list of anomalies and events data and outputs from the AI/ML described herein can comprise clusters/classes of failure modes and interpretation. Additionally, at 404, the AI/ML described herein can use one or more learning models/methods, such as k-means and principal component analysis (PCA), which can provide automated discovery of failure modes, as opposed to manual grouping into known which conventional systems provide, and can benefit NOC, engineering, and quality control.

Moreover, in at least some embodiments, the AI/ML described herein can be configured to enable the advanced fleet monitoring system to forecast failures (see 406). For example, at 406, inputs to the AI/ML described herein can comprise a list of labelled anomalies and events transition diagrams and outputs from the AI/ML described herein can comprise failure prediction alerts ahead of time, based on one or more rules. Additionally, at 406, the AI/ML described herein can use one or more learning models/methods, such as association rule learning and deep learning, which can provide new insights to fast-track RCA and predictability, as opposed to limited reasoning for RCA and inability to forecast failures which conventional systems provide, and can benefit NOC, engineering, and quality control.

Furthermore, in at least some embodiments the AI/ML described herein can be configured to enable the advanced fleet monitoring system to respond/initiate/act in view of 406 (see 408). For example, at 408, inputs to the AI/ML described herein can comprise failure prediction alerts and outputs from the AI/ML described herein can comprise automated energy management system control software tasks (or) initiate service request. Additionally, at 408, the AI/ML described herein can use one or more learning models/methods, such as task automation and/or Workflow orchestration, which can provide proactive and automated redressal, as opposed to reactive and manual tasks, work-order generation, which conventional systems provide, and can benefit CS, Field Service Technician (FST), Operations and Maintenance (O and M).

Likewise, in at least some embodiments the AI/ML described herein can be configured to enable the advanced fleet monitoring system to provide Gen-AI powered CS Support (see 410). For example, at 410 inputs to the AI/ML described herein can comprise outputs of all previous operations (402-408)+CS call data+company Knowledge Database (KDB) and outputs from the AI/ML described herein can comprise site summary of anomalies detected, events, tasks, history, steps taken etc. in a company's platform (E.g., ENL), Sales Force Platform (SFDC), data platform, etc. Additionally, at 410, the AI/ML described herein can use one or more learning models/methods, such as LLM and/or natural language processing (NLP), which can provide reduced call duration, holistic and effective resolution with added context from LLM trained on company KDB, and can benefit CS,

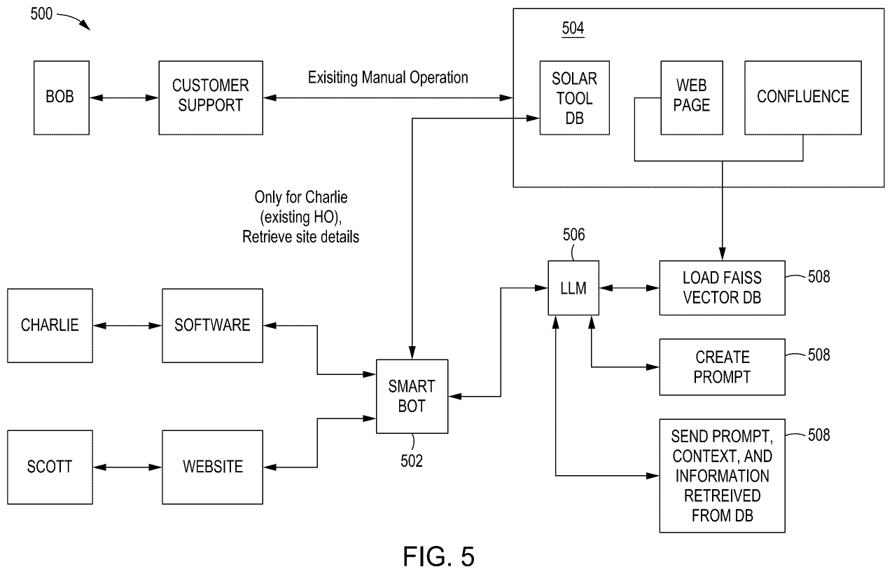

FIG. 5 is a flowchart 500 of a customer support Chatbot workflow for use with the system for power conversion of FIG. 1, in accordance with at least some embodiments of the present disclosure. For example, the HO Chatbot can provide enhanced problem-solving abilities, reduced call volume, reduced cost, improved speed, increased customer satisfaction, and improved customer-support satisfaction. For example, one or more HO Chatbots 502 can be configured to provide automated customer support to one or more customers (e.g., HO, Charlie and Scott) via one or more interfaces. In at least some embodiments, the one or more HO Chatbots 502 can communicate with or be accessed by the one or more customers via company software (e.g., Enlighten) and/or the internet (e.g., Enphase website). The one or more HO Chatbots 502 are in operable communication with one or more sources of information 504. For example, in at least some embodiments, the one or more sources of information 504 can comprise one or more databases (e.g., Enlighten database), webpages, and/or team workspaces where knowledge and collaboration meet (e.g., Confluence). As noted above, the one or more HO Chatbots 502 can use the one or more sources of information 504 to perform one or more of the operations described above (e.g., 202-216 and/or 402-410). Additionally, the one or more HO Chatbots 502 are in operable communication with one or more LLMs 506 that has access to or can be in operable communication with one or more resources 508. The one or more resources 508 can comprise one or more databases, one or more prompt generation apparatus, and/or one or more AI models. In at least some embodiments, the LLMs 506 has access to and is in operable communication with a Facebook AI Similarity Search (FAISS) database, Create a Prompt, and Mistral 7B. The one or more HO Chatbots 502 uses the information from the one or more resources to perform one or more of the operations described above (e.g., 202-216 and/or 402-410). Unlike conventional CS services that have access to a limited number of information/resources (e.g., the one or more sources of information 504), the one or more HO Chatbots 502 have access to a plethora of resources that provide the HO a fully automated CS service and improved customer experience.

As can be appreciated the flowchart 500 can be used in conjunction with any of the other above Chatbots (e.g., the IN Chatbots, the CS Chatbots, and/or the engineering Chatbot). Of course, one or more modifications/changes may need to be made to accommodate the needs of the specific type of Chatbot.

For example, with respect to the IN Chatbots, as noted above, the IN Chatbots are configured to allow an installer to execute one or more authorized tasks using the IN Chatbots without having to navigate through multiple pages on one or more user applications. For example, in at least some embodiments, an installer can input/state a problem to the IN Chatbot (e.g., consumption transformer not working correctly, check RMA submission, microinverter retire/replace, microinverter not reporting, ask for summary report, etc.). In at least some embodiments, the IN Chatbot can verify a site/location. For example, the IN Chatbot can use one or more of the above described APIs to access one or more service manager databases. In doing so, the IN Chatbot can verify with the installer that the HO site information is correct (e.g., location, type or components of the system, etc.). In at least some embodiments, the IN Chatbot can use one or more other APIs to conduct additional actions or obtain additional information. For example, in at least some embodiments, the API can be to the cloud to check backend that current transformer (CT) is okay, microinverter status, to reset or retire microinverter, or for summary report of certain data in a view specific to an installers' request. Alternatively or additionally, the API can be to a company service manager database to check, for example, RMA stage.

In at least some embodiments, when appropriate, the IN Chatbot can retrieve information from trained support materials to guide an installer to do one or more steps, e.g., following a pre-published/trained support guide that is AI fed.

In at least some embodiments, the IN Chatbot can be used for fleet management. For example, when an installer has multiple sites (e.g., thousands), the installer can ask the IN Chatbot to “find all CT problems in my fleet and fix them.” In such embodiments, the above steps can be performed on/for all sites and a summation of information can be orchestrated back and forth with the installer/IN Chatbot.

While the foregoing is directed to embodiments of the present disclosure, other and further embodiments of the disclosure may be devised without departing from the basic scope thereof, and the scope thereof is determined by the claims that follow.

1. An apparatus for use with energy management systems, comprising:
a user interface; and
a Chatbot in operable communication with the user interface for receiving a query and transmitting a response to the query and in operable communication with at least one of a large language model (LLM) tool/agent, a LLM service, a customer service (CS) agent, or a storage layer for developing the response to the query.

2. The apparatus of claim 1, wherein the Chatbot is a HO Chatbot and the query is a HO input entered by way of application or web configured to respond to a customer.

3. The apparatus of claim 2, wherein the HO Chatbot is configured to access external application programming interfaces (APIs) for at least one of single sign-on (SSO) services or case ticketing.

4. The apparatus of claim 2, wherein the HO Chatbot is configured to at least one or retrieve site data, case history, or a context of microinverters or solar systems.

5. The apparatus of claim 2, wherein the HO Chatbot is configured to use chain-of-thought (CoT) prompting to identify a user's intent.

6. The apparatus of claim 2, wherein the HO Chatbot is configured to call the large language model (LLM) tool/agent to execute company products specific actions or services.

7. The apparatus of claim 2, wherein the HO Chatbot is an LLM powered application configured to use retrieval-augmented generation (RAG) framework to ground the response to the query on a knowledge base.

8. The apparatus of claim 1, wherein the large language model (LLM) tool/agent comprises at least one of a forecast model, an advanced fleet monitoring systems ML insight, a status check agent, an anomaly agent, a ticketing agent, or one or more APIs.

9. The apparatus of claim 8, wherein the forecast model is an energy forecast agent.

10. The apparatus of claim 1, wherein the at least one of the large language model (LLM) tool/agent, the LLM service, the customer service (CS) agent, or the storage layer are part of an integrated AI/ML solution configured to provide a three layer solution comprising a first layer configured to identify field anomalies proactively and provide root-cause analysis, a second layer configured to take/receive inputs from the first layer and automatically perform recovery/troubleshooting/tunneling/rma steps, and a third layer configured to integrate with one or more applications and the first layer and the second layer.

11. An energy management system, comprising:
a distributed energy resource (DER) comprising a microinverter;
a distributed energy resource (DER) controller in operative communication with a cloud-based computing platform;
a user interface; and
a Chatbot in operable communication with the user interface for receiving a query and transmitting a response to the query and in operable communication with at least one of a large language model (LLM) tool/agent, a LLM service, a customer service (CS) agent, or a storage layer for developing the response to the query.

12. The energy management system of claim 11, wherein the Chatbot is a HO Chatbot and the query is a HO input entered by way of application or web configured to respond to a customer.

13. The energy management system of claim 12, wherein the HO Chatbot is configured to access external application programming interfaces (APIs) for at least one of single sign-on (SSO) services or case ticketing.

14. The energy management system of claim 12, wherein the HO Chatbot is configured to at least one or retrieve site data, case history, or a context of microinverters or solar systems.

15. The energy management system of claim 12, wherein the HO Chatbot is configured to use chain-of-thought (CoT) prompting to identify a user's intent.

16. The energy management system of claim 12, wherein the HO Chatbot is configured to call the large language model (LLM) tool/agent to execute company products specific actions or services.

17. The energy management system of claim 12, wherein the HO Chatbot is an LLM powered application configured to use retrieval-augmented generation (RAG) framework to ground the response to the query on a knowledge base.

18. The energy management system of claim 11, wherein the large language model (LLM) tool/agent comprises at least one of a forecast model, an advanced fleet monitoring systems ML insight, a status check agent, an anomaly agent, a ticketing agent, or one or more APIs.

19. The energy management system of claim 18, wherein the forecast model is an energy forecast agent.

20. The energy management system of claim 11, wherein the at least one of the large language model (LLM) tool/agent, the LLM service, the customer service (CS) agent, or the storage layer+ are part of an integrated AI/ML solution configured to provide a three layer solution comprising a first layer configured to identify field anomalies proactively and provide root-cause analysis, a second layer configured to take/receive inputs from the first and automatically perform recovery/troubleshooting/tunneling/rma steps, and a third layer configured to integrate with one or more applications and the first layer and the second layer.
